(19) United States
(12) Patent Application Publication
(10) Pub. No.: US 2025/0339908 A1
(43) Pub. Date: Nov. 6, 2025

(54) TOOL DEVICE AND METHOD

(71) Applicant: FESTOOL GMBH, Wendlingen (DE)

(72) Inventors: David MESSER, Zell unter Aichelberg (DE); Philipp EISENMANN, Bissingen (DE); Sibylle RAPP, Eislingen (DE)

(21) Appl. No.: 18/872,070

(22) PCT Filed: May 10, 2023
(86) PCT No.: PCT/EP2023/062407

§ 371 Date: Dec. 5, 2024

(30) Foreign Application Priority Data
Jun. 8, 2022 (DE) 10 2022 114 436.4

(51) Int. Cl. B23D 45/06

(52) U.S. Cl. CPC B23D 45/062

(57) ABSTRACT

A tool device including a stationary part and a shifting part which has a tool and which can be shifted relative to the stationary part and in the process carries out a shifting movement in order to set a position of the tool relative to the stationary part, and a guide means which is designed to guide the shifting part relative to the stationary part during the shifting movement. The guide means includes a guide structure that defines a movement path, and a guide part that rests on a guide contour of the guide structure and that can be moved along the movement path in order to carry out the shifting movement. The tool device includes a pressing mechanism which has a spring element which is designed to press the guide part against the guide structure, in order to reduce or eliminate play between the guide part and the guide.

The invention relates to a tool device, in particular to a saw device, comprising a stationary section, in particular a rest section for the resting of a workpiece, as well as an adjustment section which comprises a tool, in particular a saw blade and which can be adjusted relative to the stationary section whilst carrying out an adjustment movement, in order to set a position, in particular an angular position, of the tool relative to the stationary section, further comprising a guide device which is designed to guide the adjustment section relative to the stationary section given the adjustment movement, wherein the guide device comprises a guide structure which defines a movement path, as well as a guide section which bears on a guide contour of the guide structure and which for carrying out the adjustment movement is movable relative to the guide structure along the movement path. The adjustment movement is for example a pivoting movement and the guide structure in particular serves for defining a virtual pivot axis for the adjustment movement.

Regarding conventional mobile or semi-stationary bench saws, an angular position of the saw blade as a rule is set in a purely mechanical manner (thus in particular without an electric motor) via a user actuation for example by way of a first operating element. After setting the angular position, the user must fixedly clamp the saw blade in a set angular position via a further user actuation, for example by way of a second operating element. The fixedly clamping as a rule also serves for reducing or eliminating play which occurs in the radial direction of the angular setting. Such an approach is explained in U.S. Pat. No. 20,193,66577A1.

An object of the invention lies in providing a simply operable tool device which permits a reliable and precise machining of the workpiece.

The object is achieved by a tool device according to claim 1. The tool device comprises a pressing mechanism which comprises a spring element and which is designed to press the guide section against the guide structure with a pressing force on the basis of a spring force which is provided by the spring element, in order to reduce play between the guide section and the guide structure, in particular the guide contour, along the movement path.

A reliable and precise machining of the workpiece is rendered possible by way of the reduction or elimination of the play. The pressing force in particular is aligned in a radial direction with respect to the (in particular virtual) pivot axis of the adjustment movement, so that in particular play in this radial direction is reduced or eliminated. The pressing mechanism achieves the reduction or elimination of the play in an automatic manner—thus without a separate user actuation (for example for activating a clamping mechanism), as is often necessary with a conventional tool device. Consequently, the tool device is simple to operate. A fixation of the tool in the direction of the movement path is preferably effected by a self-locking drive device which serves for driving the adjustment section, in order to bring the adjustment section into the adjustment movement. Preferably, no separate user actuation (for example for activating a clamping mechanism) is accordingly also necessary for the fixation of the tool at the desired position.

Further exemplary details as well as exemplary embodiments are explained hereinafter with reference to the figures. Herein are shown in

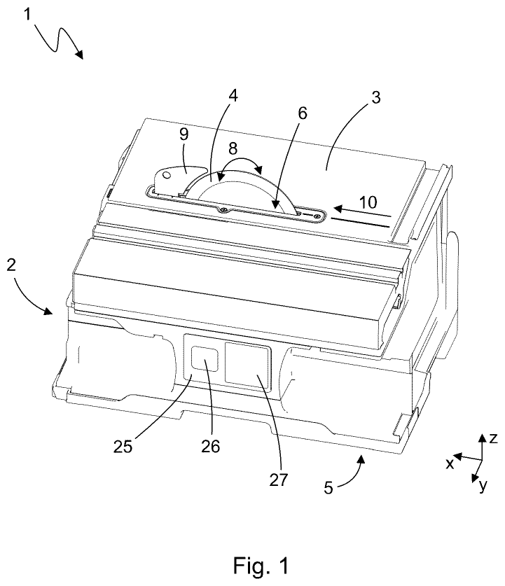

FIG. 1 a perspective representation of a tool device which by way of example is designed as a saw device,

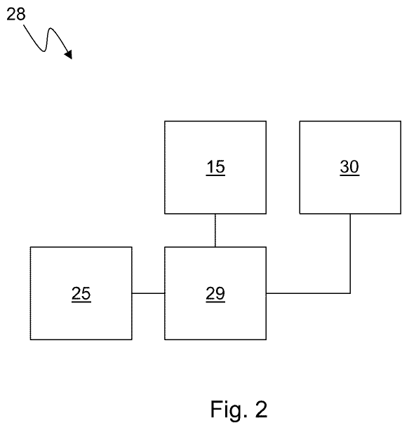

FIG. 2 a block diagram of components of the tool device,

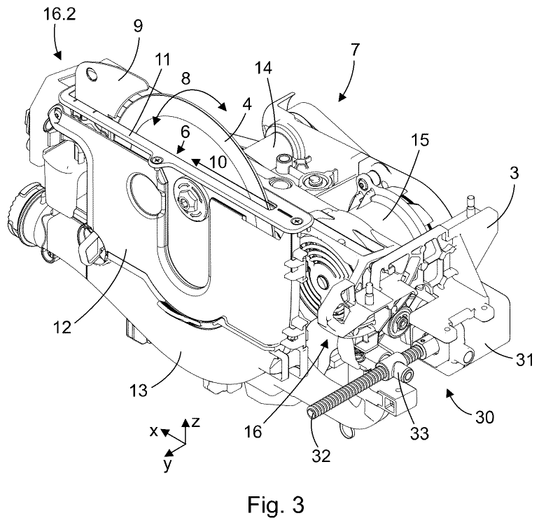

FIG. 3 a perspective view of an adjustment section, a guide device and a drive device of the tool device,

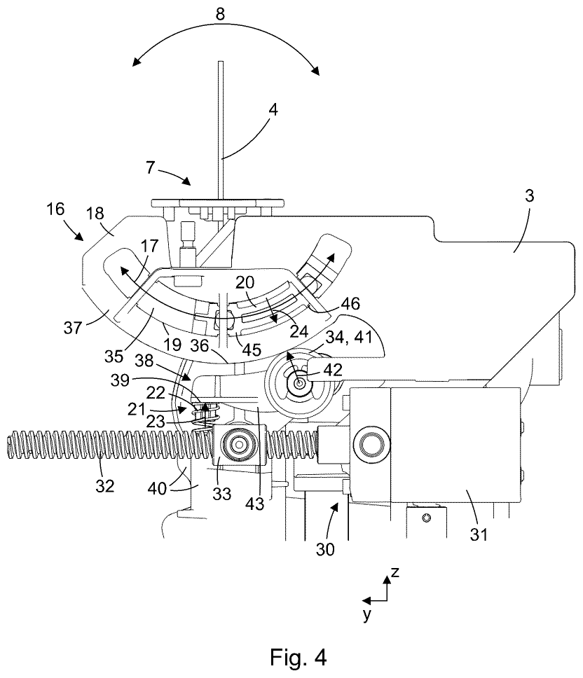

FIG. 4 a lateral view of a first end of the first end of the adjustment section,

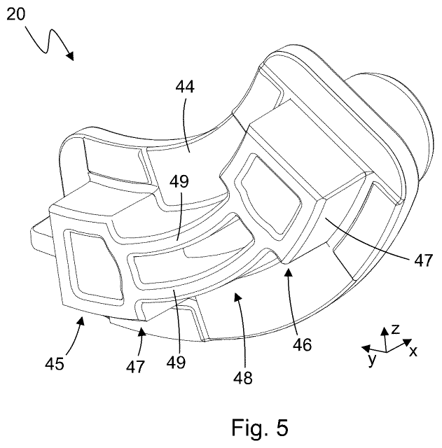

FIG. 5 a perspective view of a guide section of the tool device,

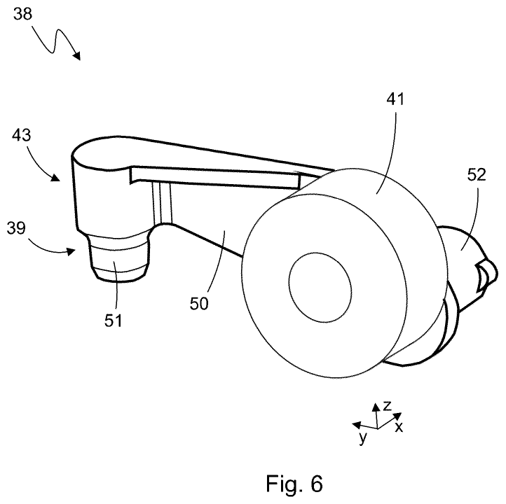

FIG. 6 a pressing arrangement of the tool device,

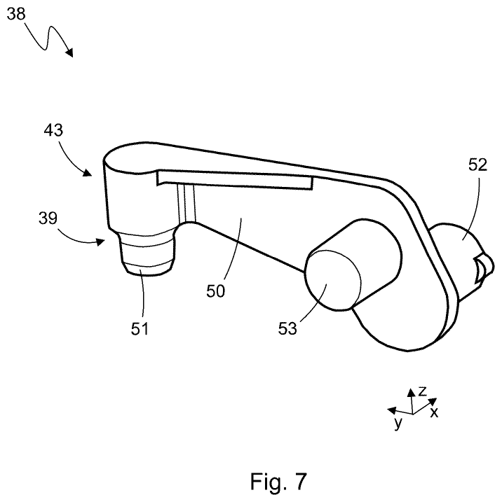

FIG. 7 a lever element of the pressing arrangement, and

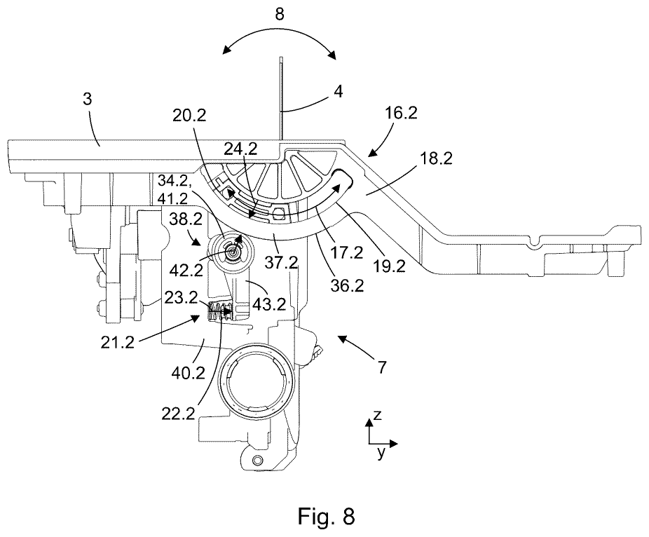

FIG. 8 a lateral view of a second end of the adjustment section.

Hereinafter, reference is made to the x-direction, y-direction and z-direction which are drawn in the figures and which are preferably aligned orthogonally to one another. The x-direction and the y-direction are directions which are horizontal (in a designated alignment of the tool device 1). The z-direction is a vertical direction and by way of example points upwards.

FIG. 1 shows a tool device 1 which by way of example is designed as a saw device, in particular as a bench saw. The tool device 1 in particular is designed as a semi-stationary device 1. A semi-stationary tool device is a tool device which on operation—thus given a machining of a workpiece—is placed on a base surface, for example a work bench or a table—in a stationary manner and which is designed in a manner (in particular with regard to its weight and/or dimensions) such that it can be carried a single person. The tool device can further be designed as a circular saw or as a mitre saw. The tool device can further be designed as a tool device which is different from a saw device, for example as a milling machine.

By way of example, the tool device 1 comprises a support structure 2 with whose lower side 5 the tool device 1 can be expediently placed on a base surface. The support structure 2 by way of example has an essentially cuboid basic shape. Expediently, the support structure 2 comprises the outer housing (or at least a part of the outer housing) of the tool device 1.

The tool device comprises a stationary section 3 which by way of example is designed as a rest section for the resting of a workpiece. The rest section for example is a rest table and in particular comprises a preferably horizontally aligned rest surface. The rest section serves for the resting of the workpiece whist it is machined with a tool 4 of the tool device 1. The stationary section 3 for example is part of the support structure 2. By way of example, the stationary section 3, in particular the rest section is formed by the upper side of the support structure 2. In a state in which the tool device 1 is placed on a base surface in a stationary manner, the stationary section 3 is expediently stationary with respect to the base surface.

The tool 4 by way of example is designed as a saw blade, in particular as a circular saw blade. By way of example, an opening 6 is present in the rest section, through which opening the tool 4 extends, in particular from within the support structure 2 through the opening 6 to outside the support structure 2, by way of example upwards to beyond the rest section. The opening 6 by way of example is provided in a plate 11. The tool 4 is arranged in the region of the rest section, so that a workpiece which is placed on the rest section can be machined by the tool 4.

The tool 4 expediently defines a feed direction 10 in which the workpiece is to be moved onto to the tool 4 (for example by hand by a user) in order to machine the workpiece with the tool 4. The feed direction 10 expediently runs parallel to the saw blade plane and/or parallel to the rest surface. The feed direction 10 by way of example is aligned parallel to the x-direction.

The tool device 1 expediently comprises an operating device 25 which by way of example is arranged at the outside on the support structure 2, in particular on a front side of the support structure 2. The operating device 25 preferably comprises an input unit 26 and/or a display unit 27. The input unit 26 can comprise for example a rotary button, in particular a rotary push button. The input unit 26 in particular serves for setting a position in particular an angular position of the tool 4 relative to the stationary section 3, for example by way of the input (by the user) of a position value which represents the position. The angular position, in particular the position value is for example an inclination angle or mitre angle of the tool 4. The display element 27 is designed for example as a graphic display and in particular is designed to display the position, for example the position value.

FIG. 2 shows a block diagram of a drive arrangement 28 of the tool device 1. The drive arrangement 28 comprises the operating device 25, a control unit 29 which is designed for example as a microcontroller, a drive unit 15 and/or a drive device 30. Expediently, the control unit 29 is communicatively connected to the operating device 25, the drive unit 15 and/or the drive device 30. The control unit 29 is expediently designed to control the drive unit 15 and/or the drive device 30, in particular according to an input of the user which is carried out by the operating device. The control unit 29, the drive unit 15 and/or the drive device 30 is expediently arranged within the outer housing of the tool device 1. The drive unit 15 expediently comprises a first electric motor and in particular serves for bringing the tool 4 into a machining movement in which the workpiece is machined, in particular sawn, by the tool. The drive device 30 expediently comprises a second electrical motor and in particular serves for bringing the tool 4 into an adjustment movement 8, in order by way of this to set the position, in particular the angular position, of the tool 4 relative to the stationary section 3.

The tool device 1 expediently comprises an adjustment section 7 and/or a guide device 16. FIG. 3 shows a perspective view of a construction which comprises the adjustment section 7, the guide device 16 and the drive device 30. By way of example, the adjustment section 7 is aligned with its longitudinal axis in the x-direction.

The adjustment section expediently comprises the tool 4. By way of example, the adjustment section 7 further comprises a riving knife 9 which is expediently arranged behind the tool 4 in the feed direction 10. Expediently, the adjustment section 7 further comprises a saw blade covering 12 which in particular is arranged below the plate 11 and serves for covering the part of the saw blade which is situated in the support structure 2. The saw blade cover 12 is for example a cassette for receiving the saw blade. By way of example, the saw blade is displaceable within the cassette in the vertical direction, in particular in the z-direction, in order to set a height of the saw blade. By way of example, the adjustment section 7 further comprises a suction channel 13 which can be expediently subjected to a vacuum (for example by way of the connection of the tool device 1 onto a suction unit) in order to suck away particles which have been produced by the machining which is carried out by the tool 4. The suction channel 13 is expediently in fluid connection with an interior of the saw blade cover 12 and by way of example is arranged at the bottom on the saw blade cover 12.

Preferably, the adjustment section 7 further comprises a drive shaft 14 which is coupled to the tool 4 and via which the tool 4 can be driven in order to carry out the machining movement. The machining movement for example is a rotation movement about a rotation axis, in particular the rotation axis of the drive shaft 14, said rotation axis running perpendicularly to the feed direction 10. Preferably, the adjustment section 7 further comprises the drive unit 15 which serves for bringing the tool 4 into the machining movement, in particular via the drive shaft 14.

The adjustment section 7 can be adjusted relative to the stationary section 3 whilst carrying out the adjustment movement 8, in order to set the position, in particular the angular position of the tool 4 relative to the stationary section 3. Expediently, the inclination angle or mitre angle of the tool 4 can be set via the adjustment movement 8. Preferably, given the adjustment movement 8 of the adjustment section 7, all components of the adjustment section 7—thus in particular the tool 4, the riving knife 9, the saw blade cover 12, the suction channel 13, the drive shaft 14 and/or the drive unit 15—carry out the adjustment movement 8.

The adjustment movement 8 is expediently a rotative movement, in particular a pivoting movement, preferably in a y-z plane. The adjustment movement is expediently effected about a (in particular virtual) pivot axis which expediently runs parallel to the feed direction 10. The pivot axis expediently runs parallel to the saw blade plane and/or parallel to the rest surface. Preferably, the (in particular virtual) pivot axis is aligned in the x-direction. What is meant by the term “virtual pivot axis” is an imaged pivot axis. The pivot axis is expediently defined by the guide device. With regard to the angular position to be set, this in particular is the angular position of the saw blade plane relative to the rest surface.

The drive device 30 by way of example is designed as a linear drive, in particular as a spindle drive. The drive device 30 in particular is designed in a self-locking manner. By way of example the drive device 30 comprises a rotary drive 31 (in particular the aforementioned second electric motor) as well as a spindle 32 which can be driven via the rotary drive 31. The drive device 30 further comprises a drive element 33 which is arranged on the spindle 32, for example a spindle nut. The drive element 33 is coupled to the adjustment section 7, in particular is fastened to this, so that the adjustment section 7 can be brought into the adjustment movement 8 by way of a movement (effected by the rotary drive 31), in particular linear movement of the drive element. The linear movement is expediently effected in a y-z plane. The rotary drive 31 is expediently fastened to the stationary section 3.

FIG. 4 shows a lateral view of the adjustment section 7, the guide device 16 and the drive device 30.

The guide device 16 is designed to guide the adjustment section 7 relative to the stationary section 3 given the adjustment movement 8. The guide device 16 comprises a guide structure 18 which defines a movement path 17. By way of example, the movement path is circular-arc shaped. The guide device 16 further comprises a guide section 20 which bears on a guide contour 19 of the guide structure 18 and which can be moved relative to the guide structure 18 along the movement path 17 for carrying out the adjustment movement 8. The movement path 17 expediently lies in a y-z plane; the movement path 17 expediently has no x-component. The movement path 17 in particular is defined by the guide contour 19.

Given the adjustment movement 8, the guide section 20 moves relative to the guide structure 18 and specifically along the movement path 17. Preferably, the guide section 20 carries out the adjustment movement 8. Preferably, the guide section 20 is part of the adjustment section 7 or is fastened to the adjustment section 7, so that the guide section 20 carries out the adjustment movement 8 as part of the adjustment section 7 or together with the adjustment section 7. Preferably, the guide structure 18 is part of the stationary section 3 or is fastened to the stationary section 3, for example to a housing of the tool device 1, in particular to the outer housing. By way of example, the guide structure 18 is stationary relative to the stationary section 3 given the adjustment movement 8.

According to an alternative design (not shown in the figures), the guide structure is part of the adjustment section and the guide section is part of the stationary section. With this design too, a relative movement of the guide section relative to the guide structure along the movement path is effected for carrying out the adjustment movement; wherein in this case the guide structure carries out the adjustment movement 8, and not the guide section.

The tool device 1 further comprises a pressing mechanism 21 which by way of example comprises a spring element 22 which is designed as a helical spring. The pressing mechanism 221 is designed to press the guide section 20 against the guide structure 18 with a pressing force 24 on the basis of a spring force 23 which is provided by the spring element 23, in order to expediently reduce or eliminate play between the guide section 20 and the guide structure 18 along the movement path 17, in particular during the adjustment movement 8 and/or during the machining movement—thus in particular during the machining of the workpiece by the tool 4.

The play which is to be eliminated or reduced includes in particular play in the radial direction with respect to the movement path 17. The radial direction expediently lies in a y-z plane and is aligned radially with respect to the (in particular virtual) pivot axis of the adjustment movement 8. Expediently, the radial direction crosses the (in particular virtual) pivot axis.

The pressing mechanism 21 in particular serves for ensuring that the guide section 20 bears on the guide structure 18, in particular on the guide contour 19, along the movement path 17—in particular along the whole movement path—in particular in a permanent manner, preferably with a constant friction force. The pressing mechanism 21 preferably succeeds in the guide section 20 bearing constantly on the guide structure 18 in every possible position along the complete movement path 17, so that no play is given between the guide section 20 and the guide structure 18, in particular in the radial direction with respect t the movement path 17. Preferably, the pressing force 24 is aligned in the radial direction with respect to the adjustment movement 8 and/or the movement path 17. By way of example, the pressing force 24 is directed in the radial direction away from the (in particular virtual) pivot axis of the adjustment movement 8. The pressing force 24 in particular is aligned perpendicularly to the pivot axis and/or the feed direction 10. The direction of the pressing force 24 expediently lies in the same plane as the adjustment movement 8.

Preferably, the pressing mechanism 21 is designed to press the guide section 20 against the guide structure 18 with the pressing force 24 along the complete movement path 17, in order to reduce or eliminate play between the guide section 20 and the guide structure 18 along the complete movement path 17. The maximal movement path 17 of the guide section 20 relative to the guide structure 18 which can be travelled is denoted as the complete movement path 17. Preferably, the pressing mechanism 21 is designed to provide an essentially constant pressing force 24 along the movement path 17, in particular the complete movement path 17.

By way of example, the guide structure 18 comprises a plate-shaped section which with its plate plane is expediently aligned normally to the x-direction, thus by way of example normally to the (in particular virtual) pivot axis of the adjustment movement 8 and/or normally to the feed direction 10. By way of example, the guide structure 18, in particular the plate-like section, comprises an in particular circular-arc shaped recess 35. Expediently, the guide section 20 is guided in the recess 35. The recess 35 has an inner edge and/or inner surface, in particular lower inner edge and/or lower inner surface, which expediently forms the guide contour 19, against which the guide section 20 is pressed with the pressing force 24.

Preferably, the pressing mechanism 21 comprises a pressing section 34 which bears on a counter-contour 36 of the guide structure 18. The counter-contour 36 is expediently formed by an outer edge and/or outer surface, in particular a lower outer edge and/or lower outer surface, of the guide structure 18, in particular of the plate-like section. The counter-contour 36 is expediently circular-arc shaped and in particular is concentric to the guide contour 19. The pressing section 34 is pressed against the counter-contour 36 with a counter-force 42 which is effected by the spring force 23.

The guide structure 18 comprises an in particular circular-arc shaped structure section 37 which comprises the guide contour 19 and/or the counter contour 36. By way of example, the guide contour 19 is arranged on a first side—by way of example the upper side—of the structure section 37 and the counter-contour 36 is arranged on a second side which is opposite to the first side—by way of example on the lower side—of the structure section 37.

The pressing section 34 is resiliently coupled to the guide section 20 by way of the spring element 22, so that the pressing section 34 is pressed against the counter contour 36 on account of the spring force 23 and the guide section 20 is pressed against the guide contour 19 (on account of the spring force 23). Expediently, the spring force 23 effects a clamping of the structure section 37 between the guide section 20 and the pressing section 34, in particular in the radial direction with respect to the adjustment movement 8. On account of the spring force 23, the guide section 20 and the pressing section 34 are pressed in the direction towards one another, and by way of this are each pressed against the structure section 37 which is located between the guide section 20 and the pressing section 34. Preferably, the pressing section 34 is biased against the guide contour 19 by way of the spring element 22, by which means the guide section 20 is biased against the counter-contour 35.

By way of example, the pressing mechanism 21 comprises a pressing arrangement 38 which comprises the pressing section 34. The spring element 22 is arranged between the support section 39 of the pressing arrangement 38 and a support location of a coupling section 40. In particular, the spring element 22 is supported with one end on the support section 39 and with the other end on the support location, so that the spring element 22 with its spring force 23 presses the support section 39 and the support location away from one another—in particular in opposite directions. The coupling section 40 is connected to the guide section 20. The coupling section 40 is preferably part of the adjustment section 7. Expediently, the guide section 20 is pressed via the coupling section 40 against the guide structure 18, in particular against the guide contour 19 by way of the spring force 23.

By way of example, the spring element 22 is arranged on the second side—thus by way of example on the lower side—of the structure section 37. The guide section 20 by way of example is arranged on the first side—thus by way of example the upper side—of the structure section 37. The coupling section 40 runs from the spring element 22—in particular from the end of the spring element 22 which is away from the structure section 37—towards the guide section 20, in particular upwards preferably past the structure section 20, in partially horizontally offset past the structure section 37.

Preferably, the pressing arrangement 38, in particular the pressing section 34 comprises a roller 41 which bears on the counter contour 36 and can roll on this. By way of example, the pressing section 34 is designed as the roller 41. The roller 41 rolls on the counter contour 36 given the adjustment movement 8. The roller 41 is pressed with the counter-force 42 against the counter-contour 36. The roller 41 for example comprises for example a ball bearing and/or is rotatably mounted via a ball bearing, by way of example on a lever element 43 of the pressing arrangement 38.

Optionally, the pressing arrangement, in particular the pressing section comprises at least one wiper section (not shown in the figures) which bears on the counter contour, in order to remove dirt of the counter-contour. For example, wiper sections can be attached in front of and behind (in the direction of the movement path) the roller, in particular on the lever element of the pressing arrangement. Given the adjustment movement, the wiper sections free a roll surface of the counter contour from dirt (for example sawdust). In this manner, the free movement of the angular adjustment—thus the free movement of the adjustment section 7—can be improved given the adjustment movement 8.

Preferably, the pressing mechanism 21, in particular the pressing arrangement 38 comprises a lever element 43 by way of which the spring force 23 is converted into the pressing force 24, and specifically in a manner such that the pressing force 24 is larger than the spring force 23, in particular in magnitude. By way of example, the lever element 43 comprises the support section 39. Expediently, the pressing section 34 is attached to the lever element 43. Alternatively, the pressing section can be part of the lever element. By way of example, the roller 41 is rotatably mounted on the lever element 43. The lever element 43 is expediently pivotably mounted on the coupling section 40, in particular about a lever element pivot axis which is aligned parallel to the x-direction.

By way of example, the pressing section 34 is coupled to the spring element 22 via the lever element 43. The lever element 43 represents a physical lever whose rotation point is formed by the mounting of the lever element 43 of the coupling section and which expediently converts the spring force 23 into the counter-force 42. By way of example, the lever element 43 represents a one-side lever, so that the spring force 23 and the counter-force 42 are located at the same side of the rotation point of the lever element 43. The counter-force 42 is expediently arranged closer to the rotation point than the spring force 23. On account of the lever which is provided by the lever element 42, the spring force 23 is converted into the counter-force 42 in a manner such that the counter-force 42 is larger than the spring force 23, in particular in magnitude.

On account of the coupling of the pressing section 34 with the guide section 20 (by way of example via the lever element 43, the spring element 22 and the coupling section 40) the increased counter-force 42 leads to an increased pressing force 24, so that the increased (with respect to the spring force 23) pressing force 24 is also effected by the lever element 43.

The biasing of the spring element 22 is advantageously independent of the position, in particular the angular position, of the tool 4, so that a friction force is preferably constant between the guide section 20 and the guide contour 19.

The pressing mechanism 21 is preferably part of the adjustment section 7 and accordingly carries out the adjustment movement 8 as part of the adjustment section 7. In particular (given the adjustment movement 8 of the adjustment element 7) the guide section 20, the coupling section 40, the spring element 22, the lever element and/or the roller 41 carry out the adjustment movement 8, in particular a together with the tool 4.

The drive device 30 is designed to drive the adjustment section 7 relative to the stationary section 3, in order to bring the adjustment section 7 into the adjustment movement 8. Preferably, the drive device 30 is designed to fix the adjustment section 7 in a fixation state relative to the stationary section 3 so that the guide section 20 is fixed relative to the guide structure 18 in the direction of the movement path 17. The fixation state is expediently always given when no drive of the adjustment section 7 is effected by the drive device 30 (in the direction of the movement path 17). Expediently, the drive device 30 is designed in a self-locking manner, so that the adjustment section 7 is always automatically fixed relative to the stationary section (in the direction of the movement path 17) by way of the drive device 30 when the drive device 30 provides no drive of the adjustment section 7 (in the direction of the movement path 17).

Additionally or alternatively to the drive device 30, the tool device 1 can comprise an in particular manually actuatable, preferably non-electrical mechanism for setting the position, in particular the angular position, of the tool 4. For example, the adjustment section 7 is movable by way of manual actuation in order to carry out the adjustment movement 8.

Preferably, no fixation of the guide section 20 relative to the guide structure 18 by way of friction fit between the guide section 20 and the guide structure 18 is given in the direction of the movement path 17 in the fixation state. What is meant by this is that the fixation of the guide section 20 which is provided in the fixation state is not effected by way of a friction fit between the guide section 20 and the guide structure 18. Instead, as is explained above, this fixation is achieved by the drive device 30, in particular the self-locking design of the drive device 30. Expediently, the drive device 30 in the fixation state provides a fixation force which fixes the guide section 20 relative to the guide structure 18 and which is a multiple larger than a friction force which is present in the fixation state between the guide section 20 and the guide structure 18.

FIG. 5 shows an exemplary embodiment of the guide section 20. The guide section 20 by way of example is designed in a one-piece manner. The guide section 20 is manufactured for example of polyoxymethylene with aramide fibres and polytetrafluoroethylene. Good sliding properties and a low wearing can be achieved by this material. The guide section 20 expediently comprises a guide section body 44 which by way of example is designed in a plate-like manner. Preferably, the guide section body 44 is aligned with its plate plane normal to the x-direction. The guide body section 44 is preferably curved so that its basic shape is circular-arc shaped. The curvature of the guide section body 44 is expediently equal to the curvature of the movement path 17.

Preferably, the guide section 20 comprises a first contact projection 45 and a second contact projection 4 which is distanced to the first contact projection 45. The distance of the two contact projections 45, 46 in the longitudinal direction of the guide section 20 and/or in the direction of the movement path 17 is expediently larger than 30%, larger than 40% or larger than 50% of the longitudinal direction of the guide section 20 and/or the extension of the guide section 20 in the direction of the movement path 17.

By way of example, the first contact projection 45 and the second contact projection 46 project perpendicularly from the plate plane of the guide section body 44, by way of example in the negative x-direction. The first contact projection 45 and the second contact projection 46 each expediently have a cuboid basic shape. The first contact projection 45 and the second contact projection 46 comprise a respective contact surface 47 with which they bear on the guide contour 19. The contact surfaces 47 are expediently curved in accordance with the guide contour 19. Normals of the contact surfaces 47 are aligned radially with respect to the pivot axis. Expediently, a contact surface 47 is arranged at a first end of the guide section 20 and the other contact surface 47 is arranged at another end of the guide section 20.

Expediently, the guide section 20 bears with the first contact projection 45 and the second contact projection 46, in particular exclusively with the first contact projection 46 and the second contact projection, on the guide contour 19. Preferably, the contact surfaces 47 in the common x-region of the guide section 20 and of the guide contour 19 represent the locations of the guide section 20 which are closest to the guide contour 19. Expediently, the guide section 20 contacts the guide contour 19 only with the contact surfaces 47. Purely optionally, the contact projections 45, 46 are connected to one another via a connection structure 48. The connection structure 48 is curved in accordance with the curvature of the movement path 17. The connection structure 48 does not bear on the guide contour 19. By way of example, the connection structure 49 comprises two connection webs 49 which run parallel to one another and in particular are curved, expediently in a circular-arc shaped manner.

Preferably, the pressing section 34 is arranged in the direction of the movement path 17 (in particular centrally) between the first contact projection 45 and the second contact projection 46. This is shown in FIG. 4. In this manner, one can achieve a uniform loading of both contact surfaces 47. The guide section 20 is pressed against the counter-contour 36 by way of the spring-biased pressing section 34 such that the guide section 20 bears with its two contact surfaces 47 on the guide contour 19 and is biased against this with a biasing force—the pressing force 24—which is constant, which is to say a force which is independent of the angular position of the tool 4.

FIGS. 6 and 7 show an exemplary embodiment of the pressing arrangement 38. The pressing arrangement 38 comprises the lever element 43 and the roller 41. The lever element 43 is designed in an elongate manner and by way of example is aligned with its longitudinal axis essentially in the y-direction. The lever element 43 comprises a main section 50 which is designed in an elongate manner. At a first end in the longitudinal direction of the lever element 43, the lever element 43 comprises a support section 39 for supporting the spring element 22. The support section 39 comprises a pin 51 which projects from the main section 50 and onto which the spring element 22 is placed (such as e.g. shown in FIG. 4). The pin 51 by way of example projects away from the main section 50 in the negative z-direction. At a second end in the longitudinal direction of the lever element 43, the lever element 43 comprises a pivot axis section 52, via which the lever element 43 is pivotably mounted on the coupling section 40 and which is expediently designed in a cylindrical manner. The pivot axis section 52 projects from the main section 50, by way of example in the positive x-direction.

FIG. 7 shows the pressing arrangement 38 without the roller 42. By way of example, the lever element 43 comprises a rotation axis section 53, on which the roller 41 is rotatably mounted. The rotation axis section 53 projects away from the main section 50, in particular in the opposite direction to the pivot axis section 52, for example in the negative x-direction. By way of example, the rotation axis section 53 and the pivot axis section 52 are arranged at opposite sides of the main section 50. In the longitudinal direction of the lever element 43, the rotation axis section 53 is expediently arranged between the support section 39 and the pivot axis section 52, preferably closer to the pivot axis section 52 in the longitudinal direction than to the support section 39, by way of example directly next to (in the longitudinal direction) the pivot axis section 52.

The guide device 16 can also be described as a first guide device, the guide structure 18 as the first guide structure, the movement path 17 as the first movement path and the guide section 20 as the first guide section.

The tool device 1 expediently further comprises a second guide device 16.2. FIG. 8 shows an exemplary design of the second guide device 16.2.

By way of example, the first guide device 16 and the second guide device 16.2 are arranged distanced to one another in the x-direction. Expediently, a respective guide device 16, 16.2 is arranged at each end in the longitudinal direction of the adjustment section 7.

The second guide device 16.2 is preferably designed as the first guide device 16 so that the aforementioned explanations which relate to the first guide device 16 expediently accordingly apply to the second guide device 16.2. Expediently, the subsequently explained components of the second guide device 16.2 are designed as the corresponding components of the first guide device 16, 2 which are explained above.

The second guide device 16.2 comprises a second guide structure 18.2 which defines a second movement path 17.2 as well as a second guide section 20.2 which bears on a second guide contour 19.2 of the second guide structure 18.2 and is movable relative to the second guide structure 18.2 along the second movement path 17.2 for carrying out the adjustment movement 8. The second movement path 17.2 preferably runs parallel to the first movement path 17. By way of example, the second guide structure 18.2 comprises a second structure section 37.2 which defines a second counter-contour 36.2.

The pressing mechanism 21 which has been explained above can also be denoted as a first pressing mechanism, the spring element 22 as the first spring element, the spring force 23 as a first spring force and the pressing force 24 as the first pressing force.

The tool device 1 expediently further comprises a second pressing mechanism 21.2. FIG. 8 shows an exemplary design of the second pressing mechanism 21.2.

By way of example, the first pressing mechanism 21 and the second pressing mechanism 21.2 are arranged distanced to one another in the x-direction.

Expediently, a respective pressing mechanism 21, 21.2 is arranged at each end in the longitudinal direction of the adjustment section 7.

The second pressing mechanism 21.2 is preferably designed as the first pressing mechanism 21 with the exception of the differences explained hereinafter, so that the above explanations which relate to the first pressing mechanism 21 expediently accordingly apply to the second pressing mechanism 21.2. Expediently, the subsequently explained components of the second pressing mechanism 21.2 are designed as the corresponding components of the first pressing mechanism 21 which are explained above.

The second pressing mechanism 21.2 comprise a second spring element 22.2 and is designed, on the basis of a second spring force 23.2 which is provided by second spring element 22.2, to press the second guide section 20.2 against the second guide structure 20.2 with a second pressing force 24.2, in order to reduce or eliminate play between the second guide section 20.2 and the second guide structure 18.2 along the second movement path 17.2, in particular in the radial direction with respect to the (in particular virtual) pivot axis of the adjustment movement 8. The second spring element 22.2 by way of example is coupled to the second guide section 20.2 via a second coupling section 40.2. The second pressing mechanism 21.2 by way of example comprises a second pressing section 34.2 which by way of example is designed as a second roller 41.2 and bears on the second counter-contour 36.2. The second pressing section 34.2 is pressed against the second guide contour 36.2 with a second counter-force 42.2 which is effected by the second spring force 23.2.

The second pressing mechanism 21.2 differs from the first pressing mechanism 21 by way of example by way of the second spring force 23.2 being aligned in another direction than the first spring force 23. By way of example, the second spring force 23.2 is aligned orthogonally to the first spring force 23. Preferably, the first spring force 23 is aligned parallel to the saw blade plane and/or the second spring force 23.2 is aligned normally to the saw blade plane. Preferably, the second pressing mechanism 21.2 comprises a second pressing arrangement 38.2 with a second lever element 43.2 which is expediently aligned with its horizontal axis orthogonally to the longitudinal axis of the first lever element 43.2.

The first pressing force 24 and the second pressing force 24.2 are expediently both aligned in the radial direction with respect to the (in particular virtual) pivot axis of the adjustment movement 8. Moreover, the first counter-force 42 and the second counter-force 42.2 are expediently both aligned in the radial direction with respect to the (in particular virtual) pivot axis of the adjustment movement 8. Expediently, the first counter-force 42 and the second counter-force 42.2 are both orientated in the same direction and/or in the same radial plane through the (in particular virtual) pivot axis, such as for example shown in a comparison of FIG. 4 and FIG. 8.

Alternatively, the second pressing mechanism 21.2 can also be designed the same as the first pressing mechanism 21 or in a mirrored manner to the first pressing mechanism 21 (in particular at a y-z mirror plane).

A method for the operation of the tool device 1 is described hereinafter. Optionally, the method begins by way of the user carrying the tool device 1 to a place of application and placing it on a base surface there. Expediently, the user then via the operating device 25 sets a desired position, in particular a desired angular position, of the tool 4 relative to the stationary section 3. The tool device 1 thereupon sets the position of the tool 4 according to the position which is inputted by the user. The tool device 1 carries out the adjustment movement 8 for this purpose. By way of the pressing mechanism 21 (and the optionally present second pressing mechanism 21.2), the tool 4 is constantly—thus in particular before, during and after the adjustment movement 8—mounted relative to the stationary section 4 in a play-free manner, in particular in the radial direction with respect to the (in particular virtual) pivot axis, about which the adjustment movement 8 is effected. The user expediently activates the drive unit 15 (for example by way of an actuation of an on-switch of the tool device 1) in order to effect the bringing of the tool 4 into the machining movement. The user places a workpiece onto the rest surface and guides the workpiece onto the tool 4 in the feed direction 4, in order to machine the workpiece with the tool 4, and specifically with the previously set position, in particular the previously set angular position. The tool 4 is also mounted relative to the stationary section 3 in a play-free manner during the machining of the workpiece, in particular in the radial direction with respect to the (in particular virtual) pivot axis of the adjustment movement 8, by way of the pressing mechanism 21 (and the optionally present second pressing mechanism 21.2). Consequently, the user does not need to carry out any separate user action (for example an activation of a clamping mechanism) after the completion of the adjustment movement 8 and/or before the machining of the workpiece, in order to fix the adjustment section 7 relative to the stationary section 3 and/or in order to achieve the play-free mounting; and expediently the user carries out no such separate user action between the completion of the adjustment movement 8 and the beginning of the machining of the workpiece. The fixation of the adjustment section 7 is automatically achieved by the self-locking drive device 30 and the play-free mounting is automatically achieved by the first and/or the second pressing mechanism 21, 21.2, so that no user action is necessary for this and is also not effected.

1. A tool device comprising a stationary section as well as an adjustment section which comprises a tool and which can be adjusted relative to the stationary section by carrying out an adjustment movement, in order to set a position of the tool relative to the stationary section, further comprising a guide device which is designed to guide the adjustment section relative to the stationary section during the adjustment movement, wherein the guide device comprises a guide structure which defines a movement path, as well as a guide section which bears on a guide contour of the guide structure and which for carrying out the adjustment movement is movable relative to the guide structure along the movement path, further comprising a pressing mechanism which comprises a spring element and which is designed to press the guide section against the guide structure with a pressing force on the basis of a spring force which is provided by the spring element, in order to reduce or eliminate play between the guide section and the guide structure along the movement path.

2. The tool device according to claim 1, wherein the adjustment movement is a rotative movement and/or the movement path is circular-arc shaped.

3. The tool device according to claim 1, wherein the pressing force is aligned radially with respect to the adjustment movement and/or the movement path.

4. The tool device according to claim 1, wherein the pressing mechanism is designed to press the guide section against the guide structure with the pressing force along the complete movement path in order to reduce or eliminate play between the guide section and the guide structure along the complete movement path.

5. The tool device according to claim 1, wherein the pressing mechanism is designed to provide the pressing force as an essentially constant pressing force along the movement path.

6. The tool device according to claim 1, wherein the pressing mechanism comprises a pressing section which bears on a counter-contour of the guide structure and is resiliently coupled to the guide section by way of the spring element, so that on account of the spring force the pressing section is pressed against the counter-contour and the guide section is pressed against the guide contour.

7. The tool device according to claim 6, wherein the guide contour is arranged on a first side of a structure section of the guide contour and the counter-contour is arranged at a second side of the structure section which is opposite to the first side.

8. The tool device according to claim 6, wherein the pressing section comprises a roller which bears on the counter-contour and can roll on the counter-contour.

9. The tool device according to claim 8, wherein the pressing section comprises at least one wiper section which bears on the counter-contour, in order to remove dirt of the counter contour.

10. The tool device according to claim 1, wherein the pressing mechanism comprises a lever element, by way of which the spring force is converted into the pressing force and specifically in a manner such that the pressing force is larger than the spring force.

11. The tool device according to claim 10, wherein the pressing mechanism comprises a pressing section which bears on a counter-contour of the guide structure and is resiliently coupled to the guide section by way of the spring element, so that on account of the spring force the pressing section is pressed against the counter-contour and the guide section is pressed against the guide contour, wherein the pressing section is coupled to the spring element via the lever element.

12. The tool device according to claim 1, wherein the guide section comprises a first contact projection and a second contact projection distanced to the first contact projection and with the first contact projection and the second contact projection bears on the guide contour.

13. The tool device according to claim 12, wherein the pressing mechanism comprises a pressing section which bears on a counter-contour of the guide structure and is resiliently coupled to the guide section by way of the spring element, so that on account of the spring force the pressing section is pressed against the counter-contour and the guide section is pressed against the guide contour, wherein the pressing section is arranged between the first contact projection and the second contact projection in the direction of the movement path.

14. The tool device according to claim 1, comprising a drive device which is designed to drive the adjustment section relative to the stationary section, in order to bring the adjustment section into the adjustment movement, and is further designed to fix the adjustment section relative to the stationary section in a fixation state, so that the guide section is fixed relative to the guide structure in the direction of the movement path.

15. The tool device according to claim 14, wherein in fixation state the fixation of the guide section relative to the guide structure in the direction of the movement path is not achieved by way of a friction fit between the guide section and the guide structure.

16. The tool device according to a claim 1, wherein the guide device is a first guide device, the guide structure a first guide structure, the movement path a first movement path and the guide section a first guide section, and wherein the tool device further comprises a second guide device which is distanced to the first guide device and which comprises a second guide structure which defines a second movement path, as well as a second guide section which bears on a second guide contour of the second guide structure and for carrying out the adjustment movement is movable relative to the second guide structure along the second movement path, wherein the pressing mechanism is a first pressing mechanism, the spring element a first spring element, the spring force a first spring force and the pressing force a first pressing force and wherein the tool device further comprises a second pressing mechanism which comprises a second spring element and which is designed, on the basis of a second spring force which is provided by the second spring element, to press the second guide section against the second guide structure with a second pressing force, in order to reduce or eliminate play between the second guide section and the second guide structure along the second movement path.

17. The tool device according to claim 16, wherein the second movement path runs parallel to the first movement path.

18. The tool device according to claim 16, wherein the second spring force is aligned in a different direction than the first spring force, wherein the first pressing force and the second pressing force are each aligned radially with respect to the adjustment movement and/or the movement path.

19. A method for operating a tool device according to claim 1, comprising the step: carrying out the adjustment movement.

20. The tool device according to claim 1, wherein the tool device is a saw device, the stationary section is a rest section for the resting of a workpiece, the tool is a saw blade, the position is an angular position of the saw blade relative to the rest section.
